(19) United States
(12) Patent Application Publication
(10) Pub. No.: US 2020/0156326 A1
(43) Pub. Date: May 21, 2020

(54) INDUCTION WELDING PROCESS FOR WELDING TWO PARTS USING AT LEAST ONE SUSCEPTOR COMPRISING DISCONTINUOUS CONDUCTIVE ELEMENTS, AND ASSEMBLY OF AT LEAST TWO PARTS OBTAINED USING SAID INDUCTION WELDING PROCESS

(71) Applicant: Airbus Operations (S.A.S.), Toulouse (FR)

(72) Inventors: Florian Chotard, Nantes (FR); Didier Trichet, Saint-Nazaire (FR); Javad Fouladgar, Saint-Nazaire (FR)

(21) Appl. No.: 16/683,544

(22) Filed: Nov. 14, 2019

(30) Foreign Application Priority Data
Nov. 15, 2018 (FR) 1860539

(51) Int. Cl. B29C 65/36; B23K 13/02; B29C 65/00

(52) U.S. Cl. CPC B29C 65/3632; B23K 13/02; B23K 2103/16; B29C 66/721; B29C 65/3676

(57) ABSTRACT

Induction welding process for welding two parts using at least one susceptor including discontinuous conductive elements, and assembly of at least two parts obtained using the induction welding process. An induction welding process can join at least first and second parts, and the process can include a step of positioning at least one susceptor, including discontinuous conductive elements, between the first and second contact faces of the first and second parts, and steps of holding the first and second parts pressed against each other and of producing an electromagnetic field to generate an induced current that engenders heating of the susceptor. An assembly of two parts can be obtained using the process.

### CROSS-REFERENCE TO RELATED APPLICATION

This application claims priority to French patent application 18 60539 filed on Nov. 15, 2018, the entire disclosure of which is incorporated by reference herein.

### TECHNICAL FIELD

The present patent application relates to an induction welding process for welding two parts using at least one susceptor comprising discontinuous conductive elements, and to an assembly of at least two parts obtained using the induction welding process.

### BACKGROUND

In FIGS. 1 through 3, an induction welding process for welding two parts 10, 12 consists in holding the parts 10, 12 pressed against each other and in producing an electromagnetic field 14 using an inductor 16 so as to generate an induced current that engenders heating at the interface of the two parts 10, 12. This heating causes the two parts 10, 12 to melt at the interface, which allows, after cooling, a joint to be obtained between the two parts 10 and 12.

Induction welding makes it possible to be able to decouple the action of holding the parts pressed against each other and the heating action, this making it possible to be able to optimize the two actions independently of each other. In addition, the heating action is carried out without contact.

However, its use to assemble parts made of composite material proves to be problematic because it is difficult to concentrate the heating at the interface. This requires a particular draping plan and requires one specific inductor to be used for each assembly configuration, which inductors are difficult to develop. However, even under these conditions, at least one of the two parts is subjected to heating, because of the appearance of induced currents in the carbon reinforcements, that may lessen the mechanical characteristics of the impacted part.

According to one operating mode shown in FIGS. 1 and 2, prior to the induction welding, a susceptor 18 is positioned at the interface, between the two contact faces F10, F12 of the two parts 10 and 12. According to one embodiment, in particular shown in FIG. 2, the susceptor 18 is a metal grid 20 that extends continuously over all the area of the interface between the two parts 10 and 12. By continuously, what is meant is that the metal grid 20 comprises electrically conductive wires that extend from one edge to the other of the metal grid 20.

The susceptor 18 allows the heating to be concentrated at the interface. Thus, it is no longer necessary to make provision for a particular draping plan for the parts 10 and 12. Since the concentration of the heating at the interface is obtained by virtue of the susceptor 18, the inductor 16 no longer needs to be designed so as to concentrate the heating at the interface. Thus, its design is simplified, and the same inductor may be used to weld various assembly configurations.

However, the presence of a susceptor 18 in the form of a metal grid 20 generates a high temperature gradient, of about 80 to 100° C. between the edges of the interface of the two parts 10, 12 and the center, as illustrated in FIG. 3. Therefore, if the temperature at the center of the interface of the parts 10, 12 is higher than the melting point Tf, in order to obtain a joint between the two parts 10, 12, the temperature Tc at the edges of the interface of the parts 10, 12 may exceed a critical temperature for thermoplastics, this possibly degrading the mechanical characteristics of the parts 10, 12.

The disclosure herein aims to remedy all or some of the drawbacks of the prior art.

### SUMMARY

To this end, one subject of the disclosure herein is an induction welding process for joining at least first and second parts having first and second contact faces joined by at least one induction weld, the induction welding process comprising a step of positioning at least one susceptor between the first and second contact faces and steps of holding the first and second parts pressed against each other and of producing an electromagnetic field so as to generate an induced current that engenders heating of the susceptor. According to the disclosure herein, the susceptor comprises a plurality of discontinuous conductive elements.

This configuration allows the appearance of a temperature gradient between the center and the edges of the susceptor to be limited and a temperature that is substantially uniform over all the area of the susceptor to be obtained.

According to another feature of the disclosure herein, each discontinuous conductive element takes the form of a closed loop.

In one configuration, the closed loop is circular and inscribed in a square with a side length shorter than or equal to 7 mm.

According to another feature, the susceptor takes the form of a sheet, the discontinuous conductive elements being positioned in the plane of the sheet.

In one configuration, the sheet has a thickness smaller than or equal to 2 mm.

According to another feature, the discontinuous conductive elements cover from 20 to 40% of the total area of the susceptor.

In one configuration, the discontinuous conductive elements are made of copper.

According to another feature, the inductor is parameterized so that the electromagnetic field has a frequency lower than 50 kHz.

According to another feature, the induction welding process comprises a step of generating at least one complementary electromagnetic field, in addition to the field generated by the inductor.

In one application, the induction welding process is used to assemble at least one stiffener and one panel, the stiffener being positioned against a contact face of the panel. In this application, the inductor is positioned opposite the contact face of the panel when it generates the electromagnetic field that produces the induction weld.

Another subject of the disclosure herein is an assembly of at least first and second parts, the assembly being obtained by implementing the induction welding process according to one of the preceding features.

### BRIEF DESCRIPTION OF DRAWINGS

Other features and advantages will become apparent from the following description of the disclosure herein, which description is given merely by way of example, with reference to the appended drawings, in which:

FIG. 1 is a side view of an induction welded assembly of two parts, illustrating one embodiment of the prior art;

FIG. 2 is a top view of the assembly shown in FIG. 1;

FIG. 3 is a curve of temperature in a cross-sectional plane of the assembly shown in FIG. 1 at the moment of the induction welding;

FIG. 4 is a side view of an induction welded assembly of two parts, illustrating one embodiment of the disclosure herein;

FIG. 5 is a top view of the assembly shown in FIG. 4;

FIG. 6 is a temperature curve in a cross-sectional plane of the assembly shown in FIG. 4 at the moment of the induction welding;

FIG. 7 is a cross-section of an assembly of two parts joined by induction welding, illustrating one embodiment of the disclosure herein;

FIG. 8 is a top view of a pattern of a susceptor, illustrating a first embodiment;

FIG. 9 is a top view of a pattern of a susceptor, illustrating a second embodiment;

FIG. 10 is a top view of a pattern of a susceptor, illustrating a third embodiment;

FIG. 11 is a top view of a susceptor, illustrating one embodiment of the disclosure herein;

FIG. 12 is a top view of a susceptor, illustrating another embodiment of the disclosure herein; and

FIG. 13 is a perspective view of a complementary electromagnetic circuit, illustrating one embodiment of the disclosure herein.

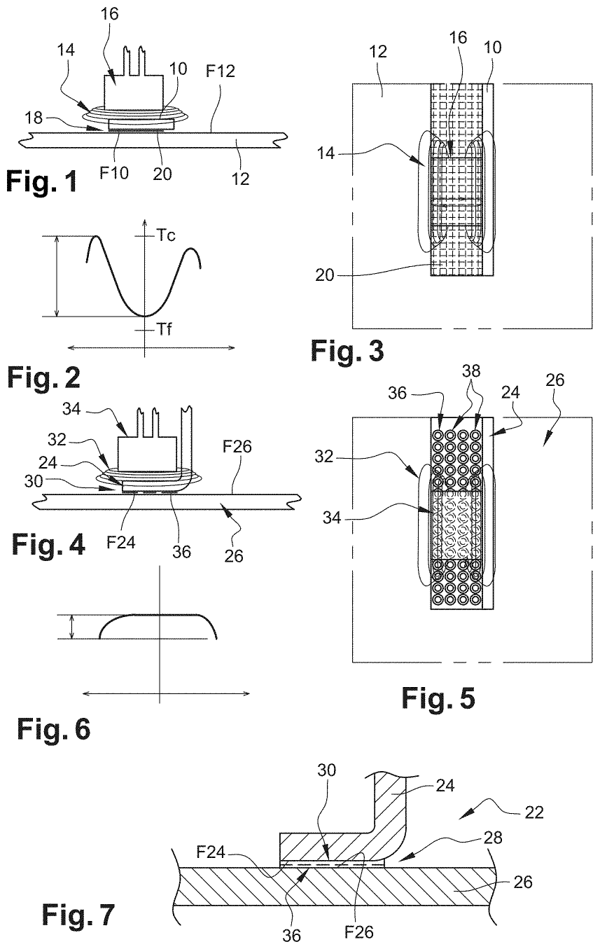

### DETAILED DESCRIPTION

FIG. 7 shows an assembly 22 comprising at least first and second parts 24, 26 that have first and second contact faces F24, F26 joined by at least one induction weld 28. Below, by an interface 30 of the first and second parts 24, 26, what is meant is the zone located between the first and second contact faces F24 and F26 and in which at least one induction weld 28 is produced.

According to one embodiment, the weld 28 is obtained using an induction welding process that comprises steps of holding the first and second parts 24, 26 pressed against each other and of producing an electromagnetic field 32 so as to generate an induced current that engenders heating at the interface 30 of the first and second parts 24, 26.

The tool used to implement the induction welding process comprises a clamping system for holding the first and second parts 24, 26 pressed against each other, and an inductor 34.

According to one embodiment, the clamping system comprises at least one peripheral seal, positioned on the periphery of the interface 30 in order to isolate it, and a pumping mechanism configured to generate a vacuum in the interface so as to hold the first and second parts 24, 26 pressed against each other.

According to another embodiment, the clamping system comprises, on the one hand, a bladder that covers at least one of the first and second parts 24, 26, at least one peripheral seal positioned on the periphery of the bladder so as to isolate a cavity in which the interface 30 is positioned and, on the other hand, a pumping mechanism configured to generate a vacuum inside the cavity so as to hold the first and second parts 24, 26 pressed against each other.

Of course, the disclosure herein is not limited to this embodiment as regards the clamping system, the latter being configured to generate a contact pressure that is substantially uniform over all the area of the first and/or second contact face(s) F24, F26.

The inductor 34 is configured to generate an electromagnetic field at the interface 30.

The assembly 22 comprises at least one susceptor 36 positioned in the interface 30, between the first and second contact faces F24, F26. The presence of a susceptor 36 allows the heating to be concentrated in the susceptor 36 and the temperature levels in the first and second parts 24, 26 to be limited. Thus, the induction welding process comprises a step of positioning at least one susceptor 36 in the interface 30, between the first and second contact faces F24, F26.

According to one feature of the disclosure herein, the susceptor 36 comprises a plurality of discontinuous conductive elements 38, which do not extend from one edge to the other of the susceptor 36. This configuration limits the appearance of a temperature gradient between the center and edges of the susceptor 36. Thus, as illustrated in FIG. 6, the temperature is substantially uniform over all the area of the susceptor 36.

The discontinuous conductive elements 38 are separate and each takes the form of a closed loop. Thus, the closed-loop shape allows the induced current generated by the electromagnetic field to be looped back onto itself.

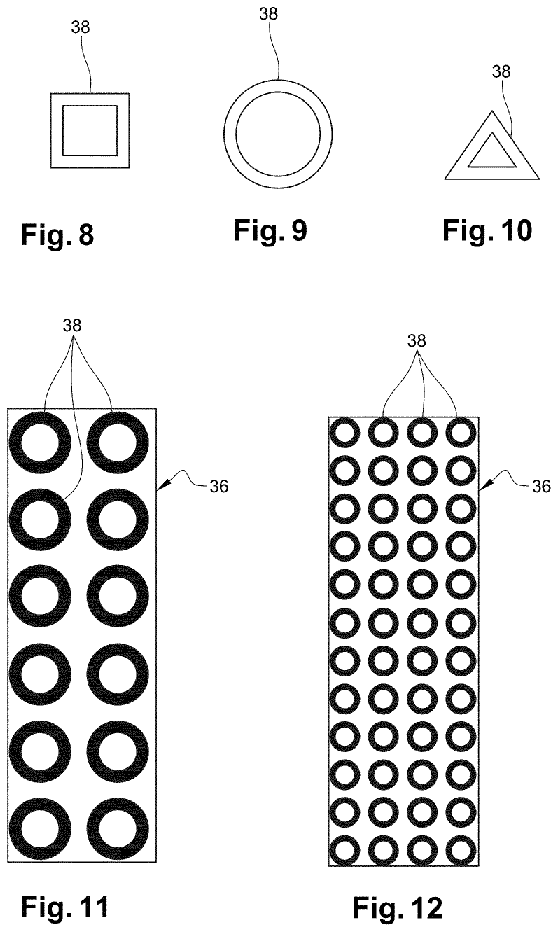

The discontinuous conductive elements 38 may each describe a square or rectangular pattern, as illustrated in FIG. 8; a circular pattern, as illustrated in FIG. 9; or a triangular pattern, as illustrated in FIG. 10. Of course, the disclosure herein is not limited to these patterns as regards the closed loops.

The susceptor 36 takes the form of a sheet comprising a plurality of discontinuous conductive elements 38 positioned in the same plane, that of the sheet. This sheet has a thickness smaller than or equal to 2 mm. In one configuration, the sheet has a thickness of about 80 μm.

According to another feature, the discontinuous conductive elements 38 cover from 20 to 40% of the total area of the susceptor 36. In one configuration, the discontinuous conductive elements 38 cover 30% of the total area of the susceptor 36.

According to one embodiment, to obtain a temperature that is uniform over a zone of the susceptor 36, the susceptor 36 has, in this zone, identical uniformly-distributed discontinuous conductive elements 38, as illustrated in FIGS. 11 and 12.

According to one embodiment shown in FIG. 11, the discontinuous conductive elements 38 are circular closed loops that are each inscribed in a square of 7 mm side length.

According to a second embodiment shown in FIG. 12, the discontinuous conductive elements 38 are circular closed loops that are each inscribed in a square of 3.5 mm side length.

Whatever the embodiment, each discontinuous conductive element 38 is inscribed in a square with a side length shorter than or equal to 7 mm.

The susceptor 36 is made of metal. According to one optimized embodiment, the susceptor 36 (and more particularly the discontinuous conductive elements 38) is made of copper.

The susceptor 36 may comprise discontinuous conductive elements 38 that are all identical, and that are distributed uniformly over all the area of the susceptor 36. As a variant, the susceptor 36 may comprise a plurality of zones each with discontinuous conductive elements 38, with different patterns from one zone to the next and/or with different distributions from one zone to the next. This configuration allows the susceptor 36 to be adapted depending on the geometry of the first and second parts 24, 26.

According to one embodiment, the inductor 34 may be identical to those of the prior art. The same inductor 34 may be used for various configurations of parts. According to the disclosure herein, it is the susceptor 36 that is adjusted depending on the configuration of the parts to be assembled and not the inductor 34.

In one configuration, the inductor 34 is parameterized so that the electromagnetic field has a frequency lower than 50 kHz, and preferably comprised between 20 and 30 kHz.

In order to obtain a power of 100 W at the susceptor 36, with a frequency of 50 kHz, an electromagnetic field of about 18400 A/m is necessary.

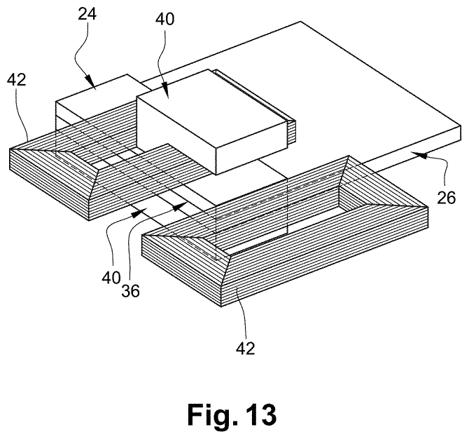

According to one embodiment, the tool for implementing the induction welding process comprises, in addition to the clamping system and the inductor 34, at least one complementary magnetic circuit 40 configured to generate a complementary electromagnetic field 42, as illustrated in FIG. 13. Thus, the induction welding process comprises a step of generating at least one complementary electromagnetic field 42, in addition to the field generated by the inductor 34. This configuration allows the power required for the induction welding to be obtained with a low-frequency, using an existing inductor 34.

In one application, the first part 24 is a stiffener that has an L-shaped cross section and the second part 26 is a panel, such as for example the skin of an aircraft. In this application, the inductor 34 is positioned opposite the contact face F26 when it generates the electromagnetic field that produces the induction weld. This configuration, combined with a low-frequency, allows the temperature in the first and second parts 24, 26 to be limited.

While at least one example embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An induction welding process for joining at least first and second parts having first and second contact faces joined by at least one induction weld, the induction welding process comprising:
positioning at least one susceptor between the first and second contact faces;
holding the first and second parts pressed against each other; and
producing an electromagnetic field to generate an induced current that engenders heating of the susceptor, wherein the susceptor comprises a plurality of discontinuous conductive elements.

2. The induction welding process according to claim 1, wherein each discontinuous conductive element takes a form of a closed loop.

3. The induction welding process according to claim 2, wherein each discontinuous conductive element is a circular closed loop and is inscribed in a square with a side length shorter than or equal to 7 mm.

4. The induction welding process according to claim 1, wherein the susceptor takes a form of a sheet, the discontinuous conductive elements being positioned in a plane of the sheet.

5. The induction welding process according to claim 4, wherein the sheet has a thickness smaller than or equal to 2 mm.

6. The induction welding process according to claim 1, wherein the discontinuous conductive elements cover from 20 to 40% of a total area of the susceptor.

7. The induction welding process according to claim 1, wherein the discontinuous conductive elements are made of copper.

8. The induction welding process according to claim 1, wherein the inductor is parameterized so that the electromagnetic field has a frequency lower than 50 kHz.

9. The induction welding process according to claim 1, wherein the induction welding process comprises generating at least one complementary electromagnetic field, in addition to the field generated by the inductor.

10. The induction welding process according to claim 1, used to assemble at least one stiffener and one panel, the stiffener being positioned against a contact face of the panel, wherein the inductor is positioned opposite the contact face of the panel when it generates the electromagnetic field that produces the induction weld.

11. An assembly of at least first and second parts, the assembly being obtained by the induction welding process according to claim 1.
